(19) United States
(12) Patent Application Publication
(10) Pub. No.: US 2025/0077098 A1
(43) Pub. Date: Mar. 6, 2025

(54) STORAGE SYSTEM

(71) Applicant: Hitachi, Ltd., Tokyo (JP)

(72) Inventor: Kentaro SHIMADA, Tokyo (JP)

(21) Appl. No.: 18/591,082

(22) Filed: Feb. 29, 2024

(30) Foreign Application Priority Data
Sep. 4, 2023 (JP) 2023-142877

(51) Int. Cl. G06F 3/06

(52) U.S. Cl. CPC G06F 3/0634; G06F 3/0604; G06F 3/0659; G06F 3/067

(57) ABSTRACT

Provided herein is a storage system capable of reducing power consumption. Each of a plurality of controllers provided to a storage system includes a plurality of first power feeding areas of which electric power is independently controllable, and a processor which processes an input/output request and a memory connected to the processor. The processor and the memory are provided to each first power feeding area. Each of the plurality of controllers is configured as being switchable between a first operating mode in which all the first power feeding areas provided to the controller are made in a working state, and a second operating mode in which one or some of the first power feeding areas provided to the controller are made in a stopped state, and the rest of the first power feeding areas is made in the working state.

### CLAIM OF PRIORITY

The present application claims priority from Japanese patent application JP 2023-142877 filed on Sep. 4, 2023, the content of which is hereby incorporated by reference into this application.

### BACKGROUND OF THE INVENTION

### 1. Field of the Invention

The present invention relates to power control of a storage system.

### 2. Description of Related Art

In a storage system which stores and outputs data in response to a data input/output request from a host machine, a processor and a memory are provided to a controller of the storage system for the sake of internal control. The processor and the memory operate at a high speed to achieve high performance, which results in large power consumption. Meanwhile, in the storage system, there is also a case in which the data input/out is not constantly requested by the host machine. In the storage system, even when there is no data input/out request from the host machine, that is, even in a waiting state, the processor of the controller keeps working so that it can detect the input/output request when it comes.

Moreover, in the storage system, when the controller stops its processing due to failure, input/output of data from/to the host machine may be disabled or the data received from the host machine may be lost. Therefore, two or more controllers are provided for redundancy of the controllers. That is, in a case in which one of two or more controllers stops processing due to failure, the rest of the controllers may take over the processing, and/or the two or more controllers redundantly store the data received from the host machine. Thus, input/output of data from/to the host machine can be continued, and the data received from the host machine can be prevented from being lost.

Reduction in power consumption is demanded also for such a storage system. Particularly, in the storage system, the processor of the controller keeps working and consuming electric power even in the waiting state in which there is no data input/out request from the host machine. Therefore, it is required that the electric power in the waiting state is reduced as much as possible in accordance with arrival of the data input/output request from the host machine.

In such a case, when the number of controllers in the storage system is three or more, redundancy can be maintained by two among the three or more controllers working. Therefore, it can be considered that the controller other than the above-described two controllers stops processing so as to cut power. One example of such a case is disclosed in JP2007-102409A.

In JP2007-102409A, power is cut on the controller basis. Therefore, in a case in which the storage system is a storage system to be provided with only two controllers, redundancy is lost when power to one of the controllers is cut, and thus the technology disclosed in JP2007-102409A is not applicable. That is, in the case in which the number of working controllers is one, input/output of data from/to the host machine cannot be continued when the one controller stops processing due to failure, which may result in losing of data received from the host machine.

### SUMMARY OF THE INVENTION

The present invention is made in view of solving the above problem, and one object thereof is to control electric power of a processor and a memory, and to reduce power consumption in a storage system without losing redundancy.

One aspect of the invention is a storage system which stores or outputs data in response to a data input/output request from a host machine. The storage system includes a plurality of controllers, and a storage device connected to the plurality of controllers. Each of the plurality of controllers includes a plurality of first power feeding areas of which electric power is independently controllable, and a processor which processes the input/output request and a memory connected to the processor, the processor and the memory being provided to each first power feeding area. Each of the plurality of controllers is switchable between a first operating mode and a second operating mode. In the first operating mode, all of the first power feeding areas provided to the controller are made in a working state. In the second operating mode, one or some of the first power feeding areas provided to the controller are made in a stopped state, and the rest of the first power feeding areas is made in the working state.

Another aspect of the invention is a storage system which stores or outputs data in response to a data input/output request from a host machine. The storage system includes a plurality of controllers. A first controller included in the plurality of controllers includes a plurality of power feeding areas of which electric power is separately controllable. A first power feeding area included in the plurality of power feeding areas includes a first processor and a first memory connected to the first processor. A second power feeding area included in the plurality of power feeding areas includes a second processor and a second memory connected to the second processor. The first processor has larger power consumption than the second processor. A second controller included in the plurality of controllers includes a plurality of power feeding areas of which electric power is separately controllable. A third power feeding area included in the plurality of power feeding areas of the second controller includes a third processor and a third memory connected to the third processor. A fourth power feeding area included in the plurality of power feeding areas of the second controller includes a fourth processor and a fourth memory connected to the fourth processor. The third processor has larger power consumption than the fourth processor. The storage system has a first operating mode and a second operating mode. In the first operating mode, the electric power of the first power feeding area is made in a working state, the electric power of the second power feeding area is made in a stopped state, the electric power of the third power feeding area is made in a working state, and the electric power of the fourth power feeding area is made in a stopped state. In the second operating mode, the electric power of the first power feeding area is made in a stopped state, the electric power of the second power feeding area is made in a working state, the electric power of the third power feeding area is made in a stopped state, and the electric power of the fourth power feeding area is made in a working state.

One aspect of the present invention can reduce power consumption of the storage system.

### BRIEF DESCRIPTION OF THE DRAWINGS

FIG. 1 illustrates a configuration example of a storage system;

FIG. 2 is a first example of a flowchart of power control;

FIG. 3 illustrates a first example of a processing sequence of a write request processing;

FIG. 4 illustrates a first example of a processing sequence of a read request processing;

FIG. 5 is a second example of a flowchart of power control;

FIG. 6 illustrates an example of a second processing sequence of the write request processing; and

FIG. 7 illustrates an example of a second processing sequence of the read request processing.

### DESCRIPTION OF THE PREFERRED EMBODIMENTS

Hereinafter, embodiments are described with reference to the drawings. Note that the embodiments are merely examples to implement the present invention and not intended to limit a technical scope of the invention. Moreover, all the combinations of features which are described in the embodiments are not necessarily essential for solution in the invention.

In the following description, various information may be described by expression of “xxx table”. However, the information may be expressed by any data structure other than the table. In order to indicate that the information does not depend on a data structure, “xxx table” may be referred to as “xxx information”. Moreover, although in the following description numbers are used as identification information of components, other types of identification information (for example, names and identifiers) may be used.

Moreover, in the following description, when components of the same type are described without being distinguished, common symbols in reference symbols (or reference symbols) may be used, and when components of the same type are described to be distinguished, reference symbols (or IDs for the respective components) may be used.

A processor (for example, a CPU (Central Processing Unit)) included in a storage controller executes a program, so that a given processing is performed by a memory resource (for example, a main memory) and/or a communication interface suitably being used. Therefore, a subject of the processing may be the storage controller or the processor. Furthermore, the storage controller may include a hardware circuit which executes a part of or the entire processing. The computer program may be installed from a program source. The program source may be, for example, a program distribution server or a computer readable storage medium.

### Embodiment 1

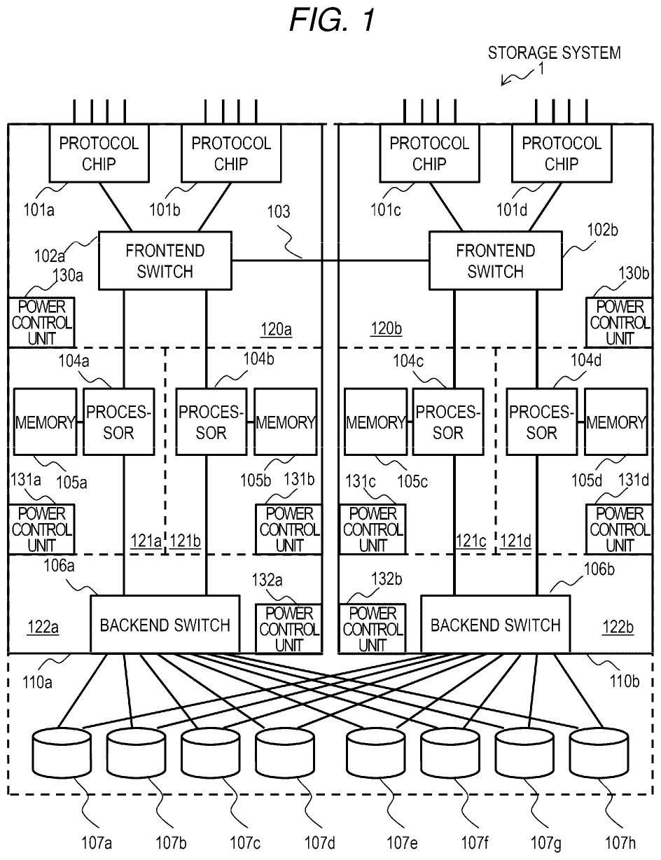

Embodiment 1 is described with reference to FIGS. 1, 2, 3, and 4. FIG. 1 illustrates a configuration example of a storage system according to Embodiment 1. In FIG. 1, a storage system 1 according to Embodiment 1 includes two controllers 110a and 110b, and eight storage devices 107a to 107h. Each of the controllers 110a and 110b is removable from the storage system 1. Therefore, the storage controller can easily be replaced.

The controller 110a includes two protocol chips 101a and 101b, one frontend switch 102a, two processors 104a and 104b, two memories 105a and 105b, and one backend switch 106a. The backend switch 106a is a storage device connecting unit.

Similarly, the controller 110b includes two protocol chips 101c and 101d, one frontend switch 102b, two processors 104c and 104d, two memories 105c and 105d, and one backend switch 106b. The backend switch 106b is a storage device connecting unit.

The two controllers 110a and 110b are connected one another through an inter-controller path 103. In FIG. 1, the inter-controller path 103 connects between the frontend switch 102a of the controller 110a and the frontend switch 102b of the controller 110b.

Each of the protocol chips 101a to 101d is connected to a host machine (not illustrated), controls a protocol of communication with the host machine, and receives a data input/output request from the host machine, or makes a response to the host machine in relation to the data input/output request.

In the storage system 1, one example of the protocol of the communication with the host machine is a Fibre Channel. Another example of the communication protocol is iSCSI (internet Small Computer System Interface). Further another example of the communication protocol is NVMe over Fabrics (Non-Volatile Memory express over Fabrics).

Although FIG. 1 illustrates the configuration example in which the two controllers 110a and 110b include the two protocol chips 101a and 101b, and the two protocol chips 101c and 101d, respectively, the number of protocol chips 101a to 101d for each controller is not limited to two, but may be any number of one or more.

The frontend switch 102a connects the protocol chips 101a and 101b to the processors 104a and 104b. The frontend switch 102a sends, to the processor 104a or 104b, a data input/output request which the protocol chips 101a and 101b receive from the host machine (not illustrated), and also sends, to the protocol chip 101a or 101b, a response, which is sent back from the processor 104a or 104b, to the host machine in relation to the data input/output request.

Similarly, the frontend switch 102b connects the protocol chips 101c and 101d to the processors 104c and 104d. The frontend switch 102b sends, to the processor 104c or 104d, a data input/output request which the protocol chips 101c and 101d receive from the host machine (not illustrated), and also sends, to the protocol chip 101c or 101d, a response, which is sent back from the processor 104c or 104d, to the host machine in relation to the data input/output request.

Furthermore, the frontend switches 102a and 102b are connected one another through the inter-controller path 103. The frontend switches 102a and 102b deliver data sent from the processor 104a or 104b of the controller 110a to the processor 104c or 104d of the controller 110b, and deliver data sent from the processor 104c or 104d of the controller 110b to the processor 104a or 104b of the controller 110a.

Although FIG. 1 illustrates the one frontend switch 102a and the one frontend switch 102b for the respective controllers 110a and 110b, the number of frontend switches for each controller is not limited to one, but may be any number of one or more.

The processors 104a to 104d cooperate with one another and perform a processing in response to the data input/output request from the host machine in the storage system 1. Although FIG. 1 illustrates the two processors 104a and 104b and the two processors 104c and 104d for the respective two controllers 110a and 110b, the number of processors for each controller is not limited to two, but may be any number of two or more.

Similarly, the memories 105a to 105d store program codes executed by the respective processors 104a to 104d, and data to be processed. Moreover, particularly, the memories 105a to 105d temporarily store data written from the host machine until the data is written to any of the storage devices 107a to 107h.

When failure occurs in the processor 104a or 104b, or the memory 105a or 105b which belongs to the controller 110a, or in the processor 104c or 104d, or the memory 105c or 105d which belongs to the controller 110b, the data written from the host machine may be lost from the controller.

Therefore, when data is written from the host machine to the memory 105a or 105b of the controller 110a, or to the memory 105c or 105d of the controller 110b, the data is copied and sent to any of the memories of the other controller and stored therein. Thus, even when the processor or the memory of one of the controllers 110a and 110b fails, the data written from the host machine is kept without being lost.

Furthermore, the memories 105a to 105d temporarily store data read from any of the storage devices 107a to 107h until the data is sent back to the host machine. Such memories 105a to 105d are typically a volatile memory such as a DRAM (Dynamic Random Access Memory). Although FIG. 1 illustrates the one memory 105a to 105d for each of the processors 104a to 104d, the number of memories for each processor is not limited to one, but may be any number of one or more.

The backend switches 106a and 106b connect the processors 104a to 104d to the storage devices 107a to 107h. Here, the backend switches 106a and 106b connect the processors 104a to 104d to the storage devices 107a to 107h in accordance with a storage protocol used by the storage devices 107a to 107h for data input/output.

A typical example of the storage protocol used by the storage devices 107a to 107h is an NVMe (Non-Volatile Memory express). Another example of the storage protocol used by the storage devices 107a to 107h is a SAS (Serial Attached Small computer system interface).

Conversion between the storage protocol used by the storage devices 107a to 107h and the communication protocol used by the processors 104a to 104d may be performed by the backend switches 106a and 106b, or by a storage protocol processing unit (not illustrated) which is provided additionally. Alternatively, the processors 104a to 104d may use software to perform the storage protocol processing.

Note that although FIG. 1 illustrates the two backend switches 106a and 106b, the number of backend switches 106a and 106b is not limited to two, but may be any number. In the case of the configuration in which the processors 104a to 104d perform the storage protocol processing using the software, the processors 104a to 104d may directly be connected to the storage devices 107a to 107h without the backend switches 106a and 106b being provided.

The storage devices 107a to 107h read or write data in response to data input/output request sent from the processors 104a to 104d via the backend switch 106a or 106b. A typical example of the storage devices 107a to 107h is an SSD (Solid State Drive) which uses a flash memory as a memory element. Another example of the storage devices 107a to 107h is an HDD (Hard Disk Drive) which uses a magnetic disk as a memory element.

The storage devices 107a to 107h may be storage devices of a single type, or may be mixture of storage devices of a plurality of types. Moreover, although FIG. 1 illustrates the eight storage devices 107a to 107h, the number of storage devices 107a to 107h is not limited to eight, but may be any number. Therefore, the storage devices 107a to 107h are not necessarily provided in the storage system 1.

In this case, in addition to the host machines, another storage system may be connected through the protocol chips 101a to 101d. Reading or writing of data may be performed by a data reading or writing request being sent from the processors 104a to 104d to the protocol chips 101a to 101d via the frontend switch 102a or 102b, and then to the another storage system connected to the protocol chips 101a to 101d.

Moreover, in FIG. 1, the controller 110a includes a power feeding area 120a, power feeding areas 121a and 121b, and a power feeding area 122a. The power feeding area 120a includes the protocol chips 101a and 101b, and the frontend switch 102a, and is controlled by a power control unit 130a such that electric power works or stops. The protocol chips 101a and 101b are connected to and communicate with the host machine. Therefore, in accordance with whether communication with the host machine is in progress, the power control unit 130a controls the working or stopping of the electric power such that the electric power does not stop while communication is in progress. Note that the power feeding area in this embodiment is an area in which on and off of electric power is independently controllable, and at least two or more power feeding areas are provided in the controller.

Various electronic devices included in the controller (for example, the processor and the memory) are provided to any of the power feeding areas, and supply and stop of operating power is controlled on the power feeding area basis. Moreover, the power feeding area is not limited to be defined as a physically determined section, but may be defined as a group of electronic devices for which on and off of operation power supply is controlled as a whole. In either definition, each electronic device included in the controller exclusively belongs to any one of the power feeding areas, and electric power is supplied or stopped on the power feeding area basis. Note that the number of electronic devices provided to the power feeding area may be any number, and one or more electronic devices may be provided.

Moreover, a concrete aspect of a configuration of the plurality of power feeding areas is, for example, what is called an electronic circuit board. For example, a plurality of power lines independent from one another are provided on the substrate, each electronic device is connected to any of the power lines, and the respective independent power lines have power terminals which are connectable/interruptible to be independent from one another. In such an aspect, for example, these power terminals may be deemed as power control units. In the case in which the power feeding areas are structured in the form described in the above concrete aspect, each power feeding area is defined as a configuration which is unremovable from the controller.

The power feeding area 121a includes the processor 104a and the memory 105a, and is controlled by a power control unit 131a so that electric power works or stops. Similarly, the power feeding area 121b includes the processor 104b and the memory 105b, and is controlled by a power control unit 131b so that electric power works or stops. Moreover, the power feeding area 122a includes the backend switch 106a, and is controlled by a power control unit 132a so that electric power works or stops.

Similarly, the controller 110b includes a power feeding area 120b, power feeding areas 121c and 121d, and a power feeding area 122b. The controller 110b is configured in a manner such that each power feeding area is unremovable from the controller 110b. The power feeding area 120b includes the protocol chips 101c and 101d, and the frontend switch 102b, and is controlled by a power control unit 130b so that electric power works or stops.

The power feeding area 121c includes the processor 104c and the memory 105c, and is controlled by a power control unit 131c so that electric power works or stops. Similarly, the power feeding area 121d includes the processor 104d and the memory 105d, and is controlled by a power control unit 131d so that electric power works or stops. Moreover, the power feeding area 122b includes the backend switch 106b, and is controlled by a power control unit 132b so that electric power works or stops.

The storage system 1 of Embodiment 1 has a plurality of operating modes including a first operating mode and a second operating mode. In the first operating mode, electric power of all the power feeding areas is in a working state. In the second operating mode, electric power of one or some of the power feeding areas is in the working state, and electric power of the rest of the power feeding areas is in a stopped state.

In Embodiment 1, first, at start-up of the system, electric power of all of the power feeding areas 120a, 120b, 121a to 121d, 122a, and 122b are made in the working state, so that all the processors 104a to 104d execute processing. This is the first operating mode.

After that, corresponding to a rate of the input/output request from the host machine, processing of one of the processors 104a and 104b in the controller 110a is stopped, and also electric power of the power feeding area 121a or 121b where the stopped processor belongs is made in the stopped state. Moreover, also in the controller 110b, processing of one of the processors 104c and 104d is stopped, and also electric power of the power feeding area 121c or 121d where the stopped processor belongs is made in the stopped state. This is the second operating mode. Therefore, when the storage system 1 operates in the second operating mode, one or some of the plurality of processors included in the controller stop, and electric power of the power feeding area where the one or some stopped processors belong is in the stopped state. Note that at least one processor included in the controller continues operation in order to process an input/output request, and electric power of the power feeding area where the continuously operating processor belongs is in the working state.

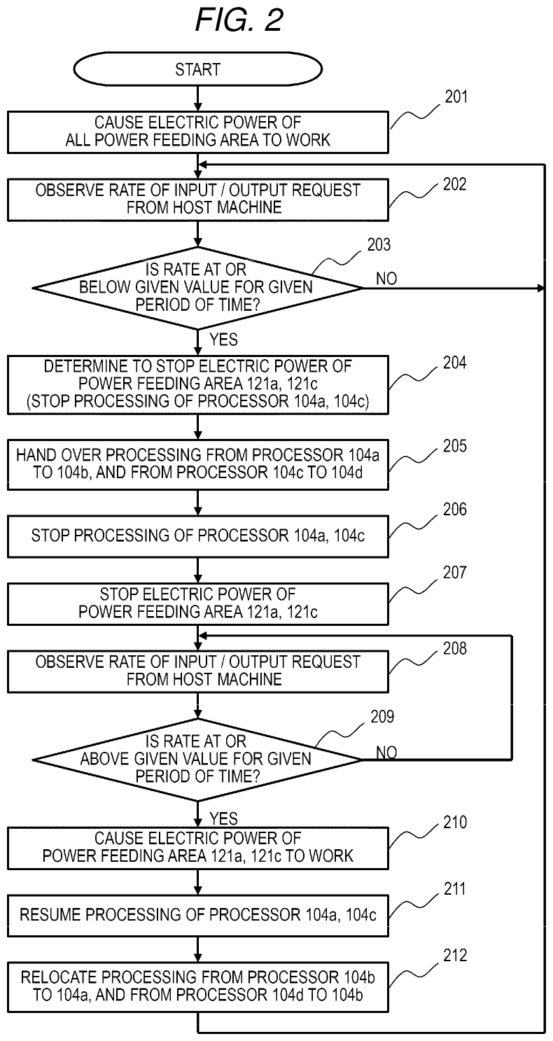

Further after that, corresponding to the input/output rate from the host machine, the stopped power feeding area 121a or 121b, and the stopped power feeding area 121c or 121d are again made in the working state, and the processing by the processor 104a or 104b, and the processor 104c or 104d where processing is stopped, is resumed. This is the first operating mode. That is, the storage system 1 shifts from the first operating mode to the second operating mode, and again shifts to the first operating mode. This situation is described with reference to FIG. 2. FIG. 2 is a flowchart of an example of power control.

201: At start-up of the storage system 1, electric power of all the power feeding areas 120a, 120b, 121a to 121d, 122a, and 122b works.

202: After that, the storage system 1 observes a rate of an input/output request from the host machine.

203: If a condition in which the rate is at or below a given value (threshold) set in advance for a given period of time set in advance is not satisfied (203: NO), this flow returns to Step 202. Therefore, the rate observation relating to the input/output request at Step 202, and the determination relating to the observation result at Step 203 are periodically executed.

204: If the rate is at or below the given value for the given period of time (203: YES), the storage system 1 determines to stop electric power of the power feeding areas 121a and 121c (stop the processing of the processor 104a and 104c). That is, when the storage system 1 according to this embodiment starts up, the storage system 1 starts operation in the first operating mode. Next, during the operation in the first operating mode, when the storage system 1 detects that the rate of the input/output request is at or below the threshold determined arbitrarily, the storage system 1 shifts to the second operating mode.

205: Next, the processor 104a hands over its processing to the processor 104b, and the processor 104c hands over its processing to the processor 104d.

206: Next, the processors 104a and 104c stop their processing.

207: Furthermore, the power control unit 131a stops electric power of the power feeding area 121a, and the power control unit 131c stops electric power of the power feeding area 121c. Therefore, at Step 207, supply of electric power to the processor 104a and the memory 105a provided to the power feeding area 121a is stopped, and supply of electric power to the processor 104c and the memory 105c provided to the power feeding area 121c is stopped.

208: After the storage system 1 shifts to the second operating mode, the storage system 1 observes the rate of the input/output request from the host machine.

209: If the rate is below a given value (threshold) set in advance for a given period of time set in advance (209: NO), this flow returns to Step 208. Therefore, the rate observation relating to the input/output request at Step 208, and the determination relating to the observation result at Step 209 are periodically executed. Note that the given period of time at this step may be the same as or different from the given period of time at Step 203.

Whether the given value at this step is larger or smaller than the given value at Step 203 is not particularly defined. However, when the given value at Step 203 is larger than the given value at this step, there may be a case in which even if the condition at Step 203 is satisfied (203: YES) and Steps 204 to 207 are executed so that electric power of the power feeding areas 121a and 121c is stopped, at Step 209, the rate of the input/output request from the host machine becomes at or above the given value for this step, and the flow immediately proceeds to the next Step 210 without returning back to Step 208.

Therefore, the given value at step 203 is desirably smaller than the given value at Step 209. That is, by the given value (203) relating to the switching from the first operating mode to the second operating mode, and the given value (208) relating to the switching from the second operating mode to the first operating mode appropriately being set, execution of unnecessary switching operation can be prevented.

210: If the rate is at or above the given value for the given period of time (209: YES), the power control unit 131a causes electric power of the power feeding area 121a to work, and the power control unit 131c causes electric power of the power feeding area 121c to work. Therefore, at Step 210, electric power to the processor 104a and the memory 105a provided to the power feeding area 121a is started to be supplied, and electric power to the processor 104c and the memory 105c provided to the power feeding area 121c is started to be supplied.

211: Furthermore, the processors 104a and 104c resume their processing.

212: After that, the processor 104b relocates to the processor 104a the processing relating to the input/output request, and the processor 104d relocates to the processor 104c the processing relating to the input/output request.

The rate observation of the input/output request from the host machine at Steps 202 and 208 may be performed by the working processor among the processors 104a to 104d, or may be performed by a special purpose processor which may separately be provided for the purpose of observation. As a method for observation, for example, a timer counter function for measuring time, etc., may be given to the processors 104a to 104d or the special purpose processor for the observation, and the time measuring function may be used to count arrival of the input/output request from the host machine within a certain period of time.

Note that the observation of other than the rate of the input/output request from the host machine, namely, the observation of another value relating to the rate of the input/output request from the host machine may be performed. For example, a processor utilization may be used instead of the rate of the input/output request from the host machine. In that case, the processor utilization may be defined by, in the working processor among the processors 104a to 104d, a ratio of time taken to process the input/output request from the host machine, garbage collection relating to the input/output request, and the like, to other time taken to wait for the input/output request from the host machine and to process rebuilding in a case of configuring self-inspection, a recovering processing, or a RAID (Redundant Array of Independent Disks) in the storage system 1 or the storage devices 107a to 107d, and the like.

In the following description, in the case in which the processor utilization is used instead of the rate of the input/output request from the host machine, the rate of the input/output request from the host machine is to be replaced with the processor utilization appropriately.

The determination of stopping electric power of the power feeding areas 121a and 121c at Step 204 may be performed by any of the processors 104a to 104d, or by the plurality of processors communicating one another to exchange or collect the observation results of the rates of the input/output request from the host machine. Alternatively, a special purpose processor for the determination processing may separately be provided to perform the determination by collecting the observation results of the rates of the input/output request from the host machine.

When the observation results of the rates of the input/output request from the host machine are communicated one another among the processors 104a to 104d, or between the special purpose processor for the determination processing and each of the processors 104a to 104d in the case where the special purpose processor is provided, a communication unit which passes the frontend switch 102a or 102b, or the backend switch 106a or 106b may be provided for communication, or a special purpose communication signal line may separately be provided for communication. Alternatively, in the case in which the special purpose processor for the observation of the rate of the input/output request from the host machine is separately provided, the processor may also undertake the determination processing.

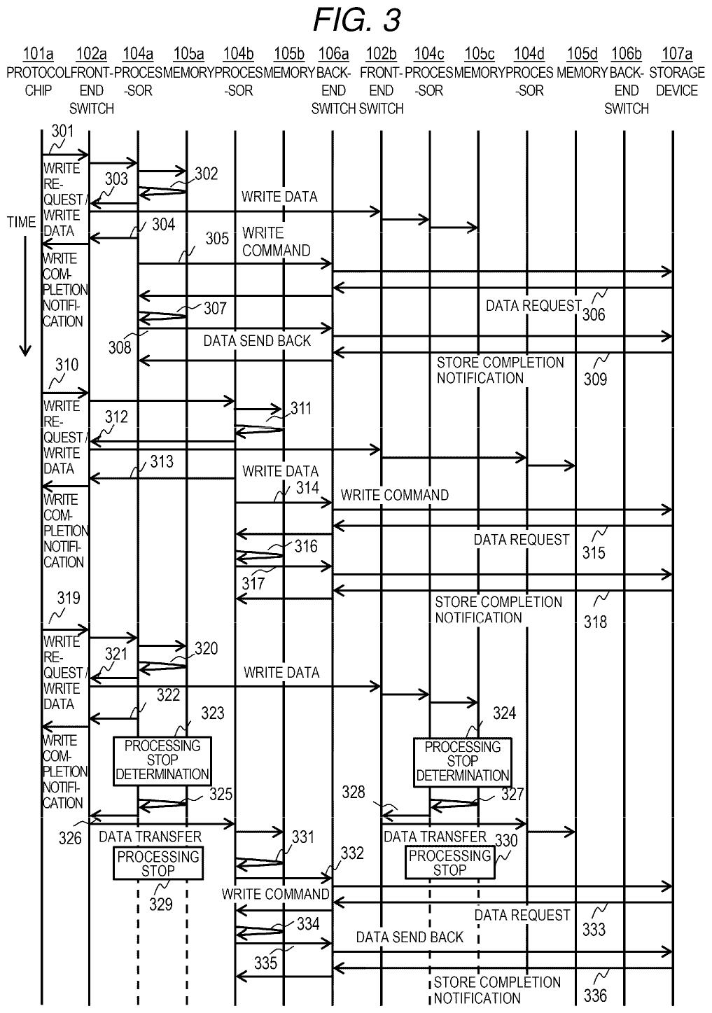

Next, an example of a processing of a write request from the host machine is described. FIG. 3 illustrates a sequence diagram of the example of the write request processing. Note that, below, operation in which the write request from the host machine is sent to the controller 110a is described as an example. However, the following operation is also applicable to a case in which the controller 110b receives the write request from the host machine, by the relation between the protocol chip, the processor, the memory, the frontend switch, and the backend switch being replaced.

301: The protocol chip 101a sends a write request received from the host machine to the memory 105a of the processor 104a.

302: The processor 104a extracts, from the memory 105a, the write request and write data from the host machine.

303: The processor 104a sends the write data to the memory 105c of the processor 104c for redundancy.

304: The processor 104a sends, to the protocol chip 101a, an instruction to notify to the host machine write request completion. When the protocol chip 101a receives the instruction to notify to the host machine the write request completion, the protocol chip 101a notifies the write request completion to the host machine.

305: The processor 104a sends a write command to the storage device 107a.

306: The storage device 107a sends a write data request to the processor 104a.

307: The processor 104a extracts, from the memory 105a, the write data. This extraction may be performed by a part of the hardware circuit of the processor 104a being provided with a function to automatically extract the write data from the memory 105a in accordance with the write data request from the storage device 107a. Alternatively, the extraction may be performed by software which is executed by the processor 104a.

308: The processor 104a sends back the write data to the storage device 107a. This sending back may also be performed by a part of the hardware circuit of the processor 104a being provided with a function to automatically send back the write data extracted from the memory 105a in accordance with the write data request from the storage device 107a. Alternatively, the sending back may be performed by software which is executed by the processor 104a.

309: The storage device 107a notifies to the processor 104a the reception and completion of storing of the write data.

310 to 318: Steps 310 to 318 are explained by replacing, in Steps 301 to 309, the processor 104a with the processor 104b, the processor 104c with the processor 104d, the memory 105a with the memory 105b, and the memory 105c with the memory 105d.

Next, processing which is executed with respect to both of the controllers 110a and 110b when the write request from the host machine is sent to the controller 110a, and the controllers 110a and 110b are determined to be shifted from the first operating mode to the second operating mode is described at Steps 319 to 336. Note that the processor and the memory which are stopped are not limited to the example described below, but may be an other processor and memory in each controller.

319 to 322: These steps are similar to Steps 301 to 304.

323: Any of the processors determines to stop the processor 104a and the memory 105a. That is, electric power of the power feeding area 121a is determined to be stopped. In other words, Step 323 indicates the determination that the controller 110a is shifted from the first operating mode to the second operating mode where the processor 104a and the memory 105a are stopped.

324: Any of the processors determines to stop the processor 104c and the memory 105c. That is, electric power of the power feeding area 121c is determined to be stopped. In other words, Step 324 indicates the determination that the controller 110b is shifted from the first operating mode to the second operating mode where the processor 104c and the memory 105c are stopped.

325: The processor 104a extracts, from the memory 105a, the write data for preserving the write data.

326: The processor 104a sends the write data to the memory 105b of the processor 104b for preserving the write data.

327: The processor 104c extracts, from the memory 105c, the write data for preserving the write data.

328: The processor 104c sends the write data to the memory 105d of the processor 104d for preserving the write data.

329: The processor 104a and the memory 105a stop operation. That is, the power control unit 131a stops electric power of the power feeding area 121a.

330: The processor 104c and the memory 105c stop operation. That is, the power control unit 131c stops electric power of the power feeding area 121c.

331: The processor 104b identifies, on the memory 105b, the write data transferred from the processor 104a. That is, the processor 104b identifies the write request from the host machine.

332 to 336: Steps 332 to 336 are similar to Steps 314 to 318.

As described above, in terms of the write request (data storage request) from the host machine, when all of the power feeding areas are working, the write request may be received and processed by either one of the processors 104a and 104b of the controller 110a.

When the power feeding areas 121a and 121c are stopped, that is, when the processors 104a and 104c are stopped, the processor 104a can hand over the write request received from the host machine to the processor 104b. Furthermore, the write data from the host machine, which is a copy sent from the memory 105a of the processor 104a of the controller 110a to the memory 105c of the processor 104c of the controller 110b to be stored therein, is transferred also from the memory 105c of the processor 104c to the memory 105d of the processor 104d. Therefore, even in a case in which some kind of failure occurs in the processor 104b or the memory 105b in the controller 110a, to which the write data from the host machine is transferred, the write data from the host machine can be prevented from being lost.

Moreover, in the processing sequence of the write request described above, the case in which the switching from the first operating mode to the second operating mode is executed when the controller 110a receives the write request is presented. When a new write request is sent from the host machine after completion of the above-described switching, the processor and the memory included in the operating power feeding area execute the operation of Steps 301 to 309.

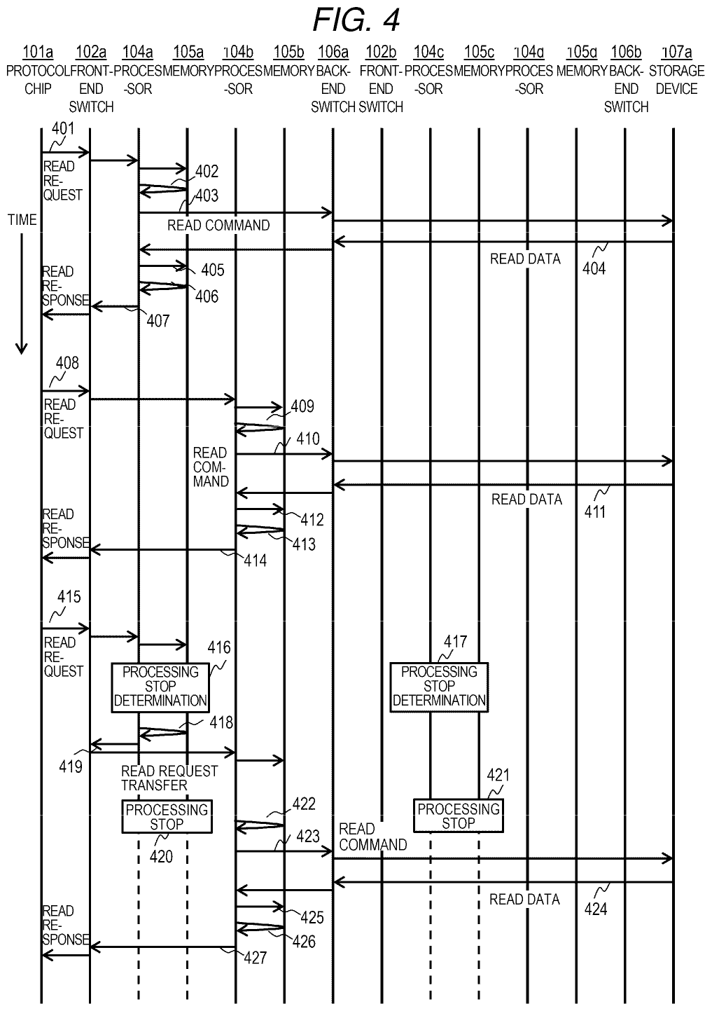

Next, an example of a processing of a read request from the host machine is described. FIG. 4 illustrates a sequence diagram of the example of the read request processing. Note that, below, operation in which the read request from the host machine is sent to the controller 110a is described as an example. However, the following operation is also applicable to a case in which the controller 110b receives the read request from the host machine, by the relation between the protocol chip, the processor, the memory, the frontend switch, and the backend switch being replaced.

401: The protocol chip 101a sends a read request received from the host machine to the memory 105a of the processor 104a.

402: The processor 104a extracts, from the memory 105a, the read request from the host machine.

403: The processor 104a sends a read command to the storage device 107a.

404: The storage device 107a sends back read data to the processor 104a.

405: The processor 104a stores, in the memory 105a, the read data from the storage device 107a. This storing of the read data may be performed by a part of the hardware circuit of the processor 104a being provided with a function to automatically store the read data in the memory 105a in accordance with the sending back of the read data from the storage device 107a. Alternatively, the storing may be performed by software which is executed by the processor 104a.

406: The processor 104a extracts, from the memory 105a, the read data.

407: The processor 104a sends, to the protocol chip 101a, an instruction to send to the host machine a read response containing the read data, and the read data. When the protocol chip 101a receives the instruction to send to the host machine the read response containing the read data, and the read data, the protocol chip 101a sends the read response containing the read data to the host machine.

408 to 414: Steps 408 to 414 can be explained by replacing, in Steps 401 to 407, the processor 104a to the processor 104b, and the memory 105a to the memory 105b.

415: The protocol chip 101a sends a read request received from the host machine to the memory 105a of the processor 104a. This step is similar to Step 401.

416: Any of the processors determines to stop the processor 104a and the memory 105a. That is, electric power of the power feeding area 121a is determined to be stopped. This step is similar to Step 323.

417: Any of the processors determines to stop the processor 104c and the memory 105c. That is, electric power of the power feeding area 121c is determined to be stopped. This step is similar to Step 324.

418: The processor 104a extracts, from the memory 105a, the read request from the host machine for preserving the read request.

419: The processor 104a sends the read request from the host machine to the memory 105b of the processor 104b for preserving the read request.

420: The processor 104a and the memory 105a stop operation. That is, the power control unit 131a stops electric power of the power feeding area 121a. This step is similar to Step 329.

421: The processor 104c and the memory 105c stop operation. That is, the power control unit 131c stops electric power of the power feeding area 121c. This step is similar to Step 330.

422: The processor 104b extracts, from the memory 105b, the read request from the host machine transferred from the processor 104a.

423 to 427: Steps 423 to 427 are similar to Steps 410 to 414.

As described above, in terms of the read request from the host machine, when all of the power feeding areas are working, the read request may be received and processed by either one of the processors 104a and 104b of the controller 110a. When the power feeding area 121a is stopped, that is, when the processor 104a is stopped, the processor 104a can hand over the read request received from the host machine to the processor 104b. Moreover, in the processing sequence of the read request described above, the case in which the switching from the first operating mode to the second operating mode is executed when the controller 110a receives the read request is presented. When a new read request is sent from the host machine after completion of the above-described switching, the processor and the memory included in the operating power feeding area execute the operation of Steps 401 to 407.

### Embodiment 2

Embodiment 2 is described with reference to FIGS. 1, 5, 6, and 7. Configurations of the storage system according to Embodiment 2 are similar to the configurations of the storage system according to Embodiment 1. A configuration example of the storage system according to Embodiment 2 is illustrated in FIG. 1. Explanation of FIG. 1 is omitted since it is similar to that in Embodiment 1. However, in Embodiment 2, the processors 104a and 104c have larger power consumption than the processors 104b and 104d, and the power consumption of the processors 104b and 104d is smaller than that of the processors 104a and 104c by a sufficient amount (for example, 1/10 or smaller). For example, the processor 104a, 104c with larger power consumption may achieve higher performance than the processor 104b, 104d with smaller power consumption.

The storage system of Embodiment 2 has a plurality of operating modes including a first operating mode and a second operating mode. In the first operating mode and the second operating mode, one or some of the power feeding areas are in the working state, and one or some of the power feeding areas are in the stopped state. The power feeding areas in the working state are different between in the first operating mode and in the second operating mode.

In Embodiment 1, first, all of the power feeding areas 120a, 120b, 121a to 121d, 122a, and 122b are made in the power working state. On the other hand, in Embodiment 2, first, only the power feeding areas 120a and 120b, the power feeding area 121a including the processor 104a and the memory 105a, the power feeding area 121c including the processor 104c and the memory 105c, and the power feeding areas 122a and 122b are made in the power working state. The power feeding area 121b including the processor 104b and the memory 105b, and the power feeding area 121d including the processor 104d and the memory 105d are made in the power stopped state. This is the first operating mode.

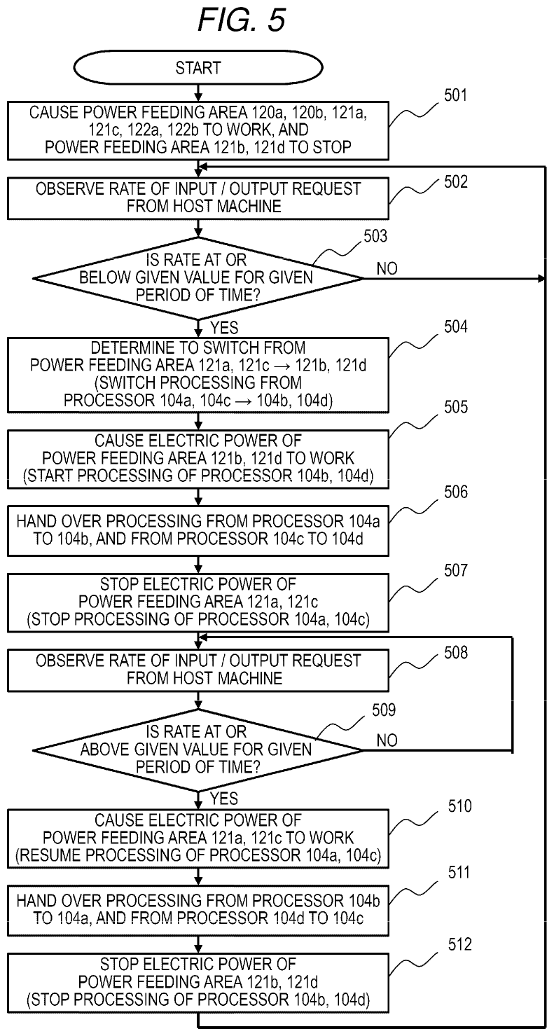

After that, corresponding to a rate of the input/output request from the host machine, the power feeding area 121a and the power feeding area 121c are made in the power stopped state, and the power feeding area 121b and the power feeding area 121d are made in the power working state. This is the second operating mode. Therefore, power consumption can be reduced. A power control according to this embodiment is described. FIG. 5 is a flowchart of an example of the power control.

501: At start-up of the storage system 1, the power feeding areas 120a, 120b, 121a, 121c, 122a, and 122b work, and the power feeding areas 121b and 121d stop.

502: After that, the storage system 1 observes the rate of the input/output request from the host machine.

503: If a condition in which the rate is at or below a given value (threshold) set in advance for a given period of time set in advance is not satisfied (503: NO), this flow returns to Step 502.

504: If the rate is at or below the given value for the given period of time (503: YES), the storage system 1 determines to switch the working power feeding area from the power feeding areas 121a and 121c to the power feeding areas 121b and 121d. That is, switching of processing from the processors 104a and 104c to the processors 104b and 104d is determined.

505: The power control units 131b and 131d respectively cause electric power of the power feeding areas 121b and 121d to work. Therefore, the processing of the processors 104b and 104d starts.

506: The processor 104a hands over its processing to the processor 104b, and the processor 104c hands over its processing to the processor 104d.

507: The power control units 131a and 131c respectively stop electric power of the power feeding areas 121a and 121c. Therefore, the processing of the processors 104a and 104c stops.

508: The storage system 1 observes the rate of the input/output request from the host machine.

509: If a condition in which the rate is at or above a given value (threshold) set in advance for a given period of time set in advance is not satisfied (509: NO), this flow returns to Step 508. The given period of time at this step may be the same as or different from the given period of time at Step 503. Whether the given value at this step is larger or smaller than the given value at Step 503 is not particularly defined. However, when the given value at Step 503 is larger than the given value at this step, there may be a case in which even if the condition at Step 503 is satisfied (503: YES) and Steps 504 to 507 are executed so that electric power of the power feeding areas 121b and 121d work, and electric power of the power feeding areas 121a and 121c stop, at Step 509, the rate of the input/output request from the host machine becomes at or above the given value for this step, and the flow immediately proceeds to the next Step 510 without returning back to Step 508. Therefore, the given value at step 503 is desirably smaller than the given value at Step 509.

510: If the rate is at or above the given value for the given period of time (509: YES), the power control units 131a and 131c respectively cause electric power of the power feeding areas 121a and 121c to work. Therefore, the processing of the processors 104a and 104c resumes.

511: The processor 104b hands over its processing to the processor 104a, and the processor 104d hands over its processing to the processor 104c.

512: The power control units 131b and 131d respectively stop electric power of the power feeding areas 121b and 121d. Therefore, the processing of the processors 104b and 104d stops.

The rate observation of the input/output request from the host machine at Steps 502 and 508 may be performed by the working processor among the processors 104a to 104d, or may be performed by a special purpose processor which may separately be provided for the purpose of observation. As a method for observation, for example, similarly to Embodiment 1, a timer counter function for measuring time, etc., may be given to the processors 104a to 104d or the special purpose processor for the observation, and the time measuring function may be used to count arrival of the input/output request from the host machine within a certain period of time.

Note that, similarly to Embodiment 1, also the observation of other than the rate of the input/output request from the host machine, namely, the observation of another value relating to the rate of the input/output request from the host machine may be performed. For example, in terms of the working processor among the processors 104a to 104d, similarly to Embodiment 1, a processor utilization etc. may be used instead of the rate of the input/output request from the host machine. In the following description, in the case in which the processor utilization is used instead of the rate of the input/output request from the host machine, the rate of the input/output request from the host machine is to be replaced with the processor utilization appropriately.

The determination of switching from the power feeding areas 121a and 121c to the power feeding areas 121b and 121d at Step 504 may be performed by one of the processors 104a and 104c, or by the plurality of processors communicating one another to exchange or collect the observation results of the rates of the input/output request from the host machine. Alternatively, a special purpose processor for the determination processing may separately be provided to perform the determination by collecting the observation results of the rates of the input/output request from the host machine.

When the observation results of the rates of the input/output request from the host machine are communicated one another between the processors 104a and 104c, or between the special purpose processor for the determination processing and each of the processors 104a and 104c in the case where the special purpose processor is provided, a communication unit which passes the frontend switch 102a or 102b, or the backend switch 106a or 106b may separately be provided for communication, or a special purpose communication signal line may separately be provided for communication. Alternatively, in the case in which the special purpose processor for the observation of the rate of the input/output request from the host machine is separately provided, the processor may also undertake the determination processing.

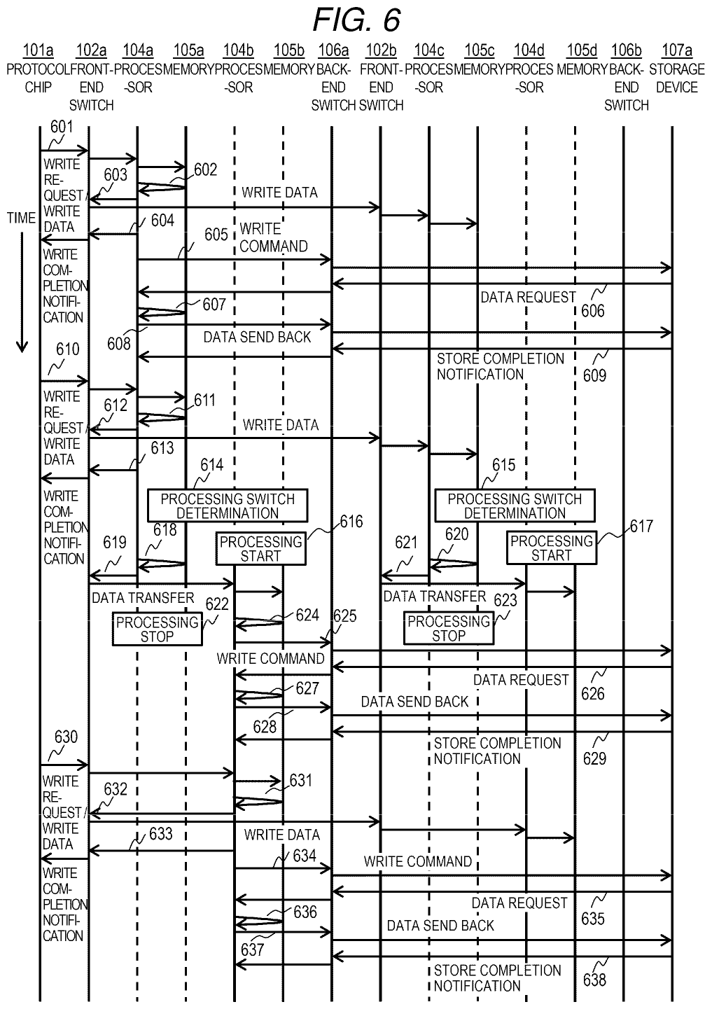

Next, an example of a processing of a write request from the host machine is described. FIG. 6 illustrates a sequence diagram of the example of the write request processing.

601: The protocol chip 101a sends a write request received from the host machine to the memory 105a of the processor 104a.

602: The processor 104a extracts, from the memory 105a, the write request and write data from the host machine.

603: The processor 104a sends the write data to the memory 105c of the processor 104c for redundancy.

604: The processor 104a sends, to the protocol chip 101a, an instruction to notify to the host machine write request completion. When the protocol chip 101a receives the instruction to notify to the host machine the write request completion, the protocol chip 101a notifies the write request completion to the host machine.

605: The processor 104a sends a write command to the storage device 107a.

606: The storage device 107a sends a write data request to the processor 104a.

607: The processor 104a extracts, from the memory 105a, the write data. This extraction may be performed by a part of the hardware circuit of the processor 104a being provided with a function to automatically extract the write data from the memory 105a in accordance with the write data request from the storage device 107a. Alternatively, the extraction may be performed by software which is executed by the processor 104a.

608: The processor 104a sends back the write data to the storage device 107a. This sending back may also be performed by a part of the hardware circuit of the processor 104a being provided with a function to automatically send back the write data extracted from the memory 105a in accordance with the write data request from the storage device 107a. Alternatively, the sending back may be performed by software which is executed by the processor 104a.

609: The storage device 107a notifies to the processor 104a the reception and completion of storing of the write data.

610 to 613: Steps 610 to 613 are similar to Steps 601 to 604.

614: Any of the working processors determines to switch the processing from the processor 104a and the memory 105a to the processor 104b and the memory 105b. That is, switching of the working power feeding area from the power feeding area 121a to the power feeding area 121b is determined.

615: Any of the working processors determines to switch the processing from the processor 104c and the memory 105c to the processor 104d and the memory 105d. That is, switching of the working power feeding area from the power feeding area 121c to the power feeding area 121d is determined.

616: The processor 104b and the memory 105b starts up. That is, the power control unit 131b turn on electric power of the power feeding area 121b.

617: The processor 104d and the memory 105d start up. That is, the power control unit 131d turn on electric power of the power feeding area 121d.

618: The processor 104a extracts, from the memory 105a, the write data for preserving the write data.

619: The processor 104a sends the write data to the memory 105b of the processor 104b for preserving the write data.

620: The processor 104c extracts, from the memory 105c, the write data for preserving the write data.

621: The processor 104c sends the write data to the memory 105d of the processor 104d for preserving the write data.

622: The processor 104a and the memory 105a stop operation. That is, the power control unit 131a stops electric power of the power feeding area 121a.

623: The processor 104c and the memory 105c stop operation. That is, the power control unit 131c stops electric power of the power feeding area 121c.

624: The processor 104b identifies, on the memory 105b, the write data transferred from the processor 104a. That is, the processor 104b identifies the write request from the host machine.

625 to 629: Steps 625 to 629 are explained by replacing, in Steps 605 to 609, the processor 104a with the processor 104b, and the memory 105a with the memory 105b.

630 to 638: Steps 630 to 638 are explained by replacing, in Steps 601 to 609, the processor 104a with the processor 104b, the processor 104c with the processor 104d, the memory 105a with the memory 105b, and the memory 105c with the memory 105d.

As described above, in terms of the write request (data storage request) from the host machine, when electric power of the power feeding area 121a and the power feeding area 121c are working, the write request may be received and processed by the processor 104a of the controller 110a. When the working power feeding areas are switched from the power feeding areas 121a and 121c to the power feeding areas 121b and 121d, that is, when the processing is switched from the processors 104a and 104c to the processors 104b and 104d, the processor 104a can hand over the write request received from the host machine to the processor 104b.

Furthermore, the write data from the host machine, which is a copy sent from the memory 105a of the processor 104a to the memory 105c of the processor 104c of the controller 110b to be stored therein, is transferred also from the memory 105c of the processor 104c to the memory 105d of the processor 104d. Therefore, even in a case in which some kind of failure occurs in the processor 104b or the memory 105b in the controller 110a, to which the write data from the host machine is transferred, the write data from the host machine can be prevented from being lost.

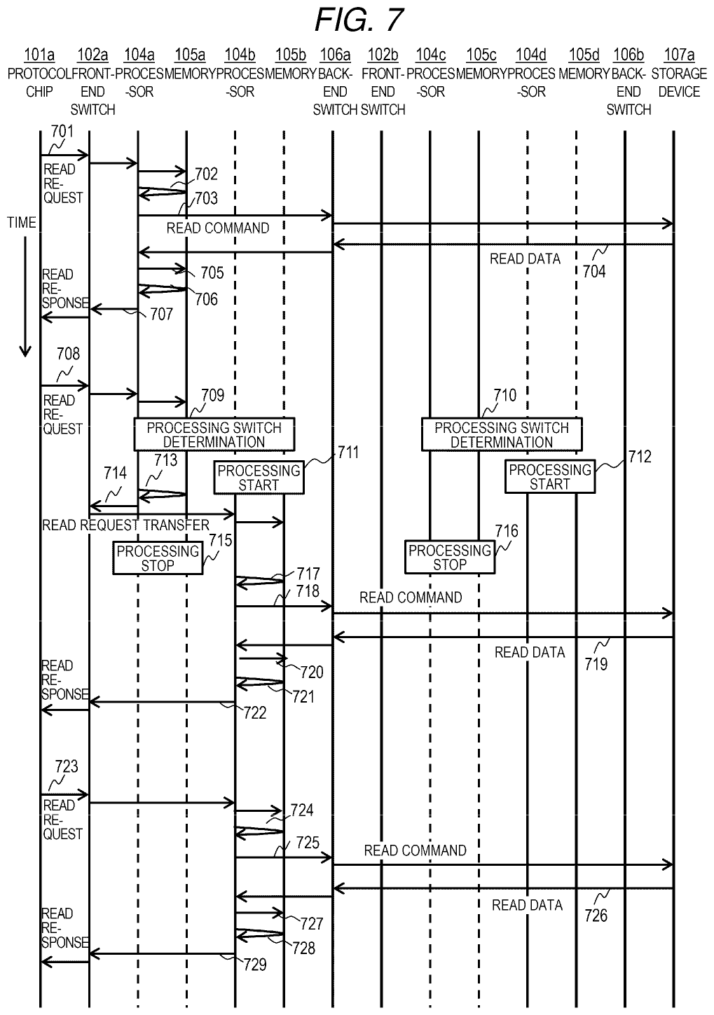

Next, an example of a processing of a read request from the host machine is described. FIG. 7 illustrates a sequence diagram of the example of the read request processing.

701: The protocol chip 101a sends a read request received from the host machine to the memory 105a of the processor 104a.

702: The processor 104a extracts, from the memory 105a, the read request from the host machine.

703: The processor 104a sends a read command to the storage device 107a.

704: The storage device 107a sends back read data to the processor 104a.

705: The processor 104a stores, in the memory 105a, the read data from the storage device 107a. This storing of the read data may be performed by a part of the hardware circuit of the processor 104a being provided with a function to automatically store the read data in the memory 105a in accordance with the sending back of the read data from the storage device 107a. Alternatively, the storing may be performed by software which is executed by the processor 104a.

706: The processor 104a extracts, from the memory 105a, the read data.

707: The processor 104a sends, to the protocol chip 101a, an instruction to send to the host machine a read response containing the read data, and the read data. When the protocol chip 101a receives the instruction to send to the host machine the read response containing the read data, and the read data, the protocol chip 101a sends the read response containing the read data to the host machine.

708: The protocol chip 101a sends a read request received from the host machine to the memory 105a of the processor 104a. This step is similar to Step 701.

709: Any of the working processors determines to switch the processing from the processor 104a and the memory 105a to the processor 104b and the memory 105b. That is, switching of the working power feeding area from the power feeding area 121a to the power feeding area 121b is determined. This step is similar to Step 614.

710: Any of the working processors determines to switch the processing from the processor 104c and the memory 105c to the processor 104d and the memory 105d. That is, switching of the working power feeding area from the power feeding area 121c to power feeding area 121d is determined. This step is similar to Step 615.

711: The processor 104b and the memory 105b start up. That is, the power control unit 131b turn on electric power of the power feeding area 121b. This step is similar to Step 616.

712: The processor 104d and the memory 105d start up. That is, the power control unit 131d turn on electric power of the power feeding area 121d. This step is similar to Step 617.

713: The processor 104a extracts, from the memory 105a, the read request from the host machine for preserving the read request.

714: The processor 104a sends the read request from the host machine to the memory 105b of the processor 104b for preserving the read request.

715: The processor 104a and the memory 105a stop operation. That is, the power control unit 131a stops electric power of the power feeding area 121a. This step is similar to Step 622.

716: The processor 104c and the memory 105c stop operation. That is, the power control unit 131c stops electric power of the power feeding area 121c. This step is similar to Step 623.

717: The processor 104b extracts, from the memory 105b, the read request from the host machine transferred from the processor 104a.

718 to 722: Steps 718 to 722 are explained by replacing, in Steps 703 to 707, the processor 104a with the processor 104b, and the memory 105a with the memory 105b.

723 to 729: Steps 723 to 729 are explained by replacing, in Steps 701 to 707, the processor 104a with the processor 104b, and the memory 105a with the memory 105b.

As described above, in terms of the read request from the host machine, when electric power of the power feeding area 121a and the power feeding area 121c are working, the read request may be received and processed by the processor 104a of the controller 110a. When the working power feeding areas are switched from the power feeding areas 121a and 121c to the power feeding areas 121b and 121d, that is, when the processing is switched from the processors 104a and 104c to the processors 104b and 104d, the processor 104a can hand over the read request received from the host machine to the processor 104b.

Note that the present invention is not limited to the above-described embodiments, but includes various modifications. For example, the embodiments provide detailed description so that the description of the invention is easily understandable, and the invention is not limited to include all the described configurations. Moreover, a partial configuration of one embodiment may be replaced by the configuration of an other embodiment, and the configuration of one embodiment may be added to the configuration of an other embodiment. Furthermore, in terms of a partial configuration of each embodiment, addition of another configuration, deletion, and replacement are possible.

Moreover, each of the configurations, functions, processing units, etc., may be implemented by hardware by, for example, a part of or all of them being designed by an integrated circuit etc. Furthermore, software may implement each of the configurations, functions, etc., by a processor interpreting and executing a program which implements each function. Information such as a program, a table, and a file which implements each function may be stored in a storage device such as a memory, a hard disk drive, and an SSD (Solid State Drive), or a storage medium such as an IC card and an SD card.

Furthermore, the control line and the information line which are considered to be necessary for explanation are illustrated, and all of the control lines and information lines of the product are not necessarily illustrated. Actually, it may be considered that substantially all the configurations are connected one another.

What is claimed is:

1. A storage system configured to store or output data in response to a data input/output request from a host machine, the storage system comprising:
a plurality of controllers; and
a storage device connected to the plurality of controllers, wherein
each of the plurality of controllers includes:
a plurality of first power feeding areas of which electric power is independently controllable; and
a processor configured to process the input/output request and a memory connected to the processor, the processor and the memory being provided to each first power feeding area, and
each of the plurality of controllers is configured as being switchable between:
a first operating mode in which all of the first power feeding areas provided to the controller are made in a working state; and
a second operating mode in which one or some of the first power feeding areas provided to the controller are made in a stopped state, and the rest of the first power feeding areas is made in the working state.

2. The storage system according to claim 1, wherein the plurality of controllers are provided to be removable from the storage system, and
the plurality of first power feeding areas provided to each of the plurality of controllers are unremovable from the controller.

3. The storage system according to claim 1, wherein one of the plurality of first power feeding areas of each of the plurality of controllers includes a protocol chip connected to the host machine and configured to control a protocol of communication with the host machine, and
all of the processors of each of the plurality of controllers are configured to be able to process the data input/output request from the host machine received by the protocol chip.

4. The storage system according to claim 1, further comprising one or more storage devices, wherein
one of the plurality of first power feeding areas of each of the plurality of controllers includes a storage device connecting unit configured to connect the processors of the plurality of power feeding areas to the storage device, and
via the storage device connecting unit, the processor provided to each of the plurality of power feeding areas of each controller writes, to the storage device, data stored in the memory, and reads data stored in the storage device and stores the read data in the memory.

5. The storage system according to claim 1, wherein each of the plurality of controllers operates in:
the first operating mode when a rate of the data input/output request from the host machine is at or above a first threshold; and
the second operating mode when the rate of the data input/output request from the host machine is at or below a second threshold.

6. The storage system according to claim 1, wherein the plurality of controllers include a first controller and a second controller,
when the first controller and the second controller operate in the first operating mode,
the first controller receives write data from the host machine,
the first controller stores the write data in a first memory of the first controller,
the first controller sends a copy of the write data to the second controller,
the second controller stores the copy of the write data in a second memory of the second controller, and
at a time in which the first controller and the second controller shift from the first operating mode to the second operating mode,
when the first memory is included in the first power feeding area of which electric power is made in the stopped state in the second operating mode, the first controller transfers, to a third memory of the first controller, the write data stored in the first memory, the third memory being included in the first power feeding area of which electric power is made in the working state in the second operating mode, and
when the second memory is included in the first power feeding area of which electric power is made in the stopped state in the second operating mode, the second controller transfers, to a fourth memory of the second controller, the write data copy stored in the second memory, the fourth memory being included in the first power feeding area of which electric power is made in the working state in the second operating mode.

7. The storage system according to claim 1, wherein at least one of the plurality of controllers includes:
one or more second power feeding areas of which electric power is controllable independently from the first power feeding area; and
a protocol chip provided to the second power feeding area, and connected to the host machine to control communication with the host machine,
the second power feeding area is configured as being switchable between a working state and a stopped state, and
the second power feeding area is switched to the working state when the protocol chip is not inhibited to communicate with the host machine, and is switched to the stopped state when the protocol chip is inhibited to communicate with the host machine.

8. A storage system configured to store or output data in response to a data input/output request from a host machine, the storage system comprising:
a plurality of controllers, wherein
a first controller included in the plurality of controllers includes a plurality of power feeding areas of which electric power is independently controllable,
a first power feeding area included in the plurality of power feeding areas of the first controller includes a first processor and a first memory connected to the first processor,
a second power feeding area included in the plurality of power feeding areas of the first controller includes a second processor and a second memory connected to the second processor,
the first processor has larger electric power consumption than the second processor,
a second controller included in the plurality of controllers includes a plurality of power feeding areas of which electric power is independently controllable,
a third power feeding area included in the plurality of power feeding areas of the second controller includes a third processor and a third memory connected to the third processor,
a fourth power feeding area included in the plurality of power feeding areas of the second controller includes a fourth processor and a fourth memory connected to the fourth processor,
the third processor has larger electric power consumption than the fourth processor,
the storage system has a first operating mode and a second operating mode,
in the first operating mode, electric power of the first power feeding area is made in a working state, electric power of the second power feeding area is made in a stopped state, electric power of the third power feeding area is made in a working state, and electric power of the fourth power feeding area is made in a stopped state, and
in the second operating mode, electric power of the first power feeding area is made in a stopped state, electric power of the second power feeding area is made in a working state, electric power of the third power feeding area is made in a stopped state, and electric power of the fourth power feeding area is made in a working state.

9. The storage system according to claim 8, wherein the first controller and the second controller are removable from the storage system,
the first power feeding area and the second power feeding area of the first controller are unremovable from the first controller, and
the third power feeding area and the fourth power feeding area of the second controller are unremovable from the second controller.

10. The storage system according to claim 8, wherein one of the plurality of power feeding areas of each of the first controller and the second controller includes a protocol chip configured to control a protocol of communication with the host machine,
each of the first processor and the second processor is configured to be able to process the data input/output request from the host machine received by the protocol chip of the first controller, and
each of the third processor and the fourth processor is configured to be able to process the data input/output request from the host machine received by the protocol chip of the second controller.

11. The storage system according to claim 8, further comprising one or more storage devices, wherein
one of the plurality of power feeding areas of the first controller includes a first storage device connecting unit connected to the storage device,
one of the plurality of power feeding areas of the second controller includes a second storage device connecting unit connected to the storage device,
the first processor writes, to the storage device, data stored in the first memory, and reads data stored in the storage device and stores the read data in the first memory via the first storage device connecting unit,
the second processor writes, to the storage device, data stored in the second memory, and reads data stored in the storage device and stores the read data in the second memory via the first storage device connecting unit,
the third processor writes, to the storage device, data stored in the third memory, and reads data stored in the storage device and stores the read data in the third memory via the second storage device connecting unit, and
the fourth processor writes, to the storage device, data stored in the fourth memory, and reads data stored in the storage device and stores the read data in the fourth memory via the second storage device connecting unit.

12. The storage system according to claim 8, wherein the first controller and the second controller operate in the first operating mode when a rate of the data input/output request from the host machine is at or above a first threshold, and
the first controller and the second controller operate in the second operating mode when the rate of the data input/output request from the host machine is at or below a second threshold.

13. The storage system according to claim 8, wherein when the first controller and the second controller operate in the first operating mode,
after the first controller receives write data from the host machine, the first controller stores the write data in the first memory,
the first controller sends a copy of the write data to the second controller,
the second controller stores the copy of the write data in the third memory, and
when the first controller and the second controller operate in the second operating mode,
after the first controller receives write data from the host machine, the first controller stores the write data in the second memory,
the first controller sends a copy of the write data to the second controller, and
the second controller stores the copy of the write data in the fourth memory, and
when the first controller and the second controller shift from the first operating mode to the second operating mode,
the first controller transfers, to the second memory, the write data stored in the first memory, and
the second controller transfers, to the fourth memory, the write data copy stored in the third memory.
